(19) United States
(12) Patent Application Publication
(10) Pub. No.: US 2022/0387240 A1
(43) Pub. Date: Dec. 8, 2022

(54) Apparatus for Treating Knee Abnormalities

(71) Applicant: ERGO-FLEX TECHNOLOGIES, LLC, Conroe, TX (US)

(72) Inventors: J.T. Anderson, Conroe, TX (US); Linda C. Anderson, Conroe, TX (US)

(73) Assignee: ERGO-FLEX TECHNOLOGIES, LLC, Conroe, TX (US)

(21) Appl. No.: 17/887,175

(22) Filed: Aug. 12, 2022

Related U.S. Application Data
(63) Continuation-in-part of application No. 17/481,149, filed on Sep. 21, 2021.
Application No. 17/481,149 is a continuation of application No. 15/449,674, filed on Mar. 3, 2017, now Pat. No. 11,123,253.

(51) Int. Cl. A61H 1/02; A63B 23/04

(52) U.S. Cl. CPC A61H 1/024; A61H 1/02; A63B 23/04; A63B 23/0494; A61H 1/0237; A61H 2203/0437; A61H 2201/5061; A61H 2201/1207; A61H 2201/0103; A61H 2201/0192; A61H 2201/1633; A61H 2201/1664; A61H 2201/1623; A61H 2201/1642; A61H 2201/50; A61H 2201/0149

(57) ABSTRACT

A method of treating knee abnormalities includes securing the portion of the leg above the knee to a stationary object and securing the portion of the leg below the knee to a movable support. A force is applied to the movable support to stretch the knee joint. An apparatus for carrying out the method is also disclosed. The apparatus may be fitted with a controller system which allows the apparatus to be operated wirelessly from a mobile device running a mobile application, which may communicate with a web-based portal and/or database.

### CROSS-REFERENCE TO RELATED APPLICATIONS

This application is a continuation-in-part of U.S. patent application Ser. No. 17/481,149 filed Sep. 21, 2021, which is a continuation of U.S. patent application Ser. No. 15/449,674 filed on Mar. 3, 2017 and issued as U.S. Pat. No. 11,123,253 on Sep. 21, 2021, the entire contents of which are hereby incorporated by reference thereto.

### STATEMENT REGARDING FEDERALLY SPONSORED RESEARCH OR DEVELOPMENT

Not applicable.

### BACKGROUND OF THE INVENTION

### Field of the Invention

This invention relates to a mechanized therapeutic device and a method for treating knee abnormalities. The device includes a support for a patient and a mechanism for creating a tension force on the knee when the patient's leg is in an extended condition.

### Background of the Invention

The invention disclosed herein offers benefits for those suffering with chronic knee pain due to osteoarthritis, previous injury, failed surgery and more. Studies show that mechanical traction is more effective at decreasing pain, improving range of motion, and improving quality of life than ultrasound and exercise combined.

A knee injury can affect any of the ligaments, tendons or fluid-filled sacs (bursae) that surround a knee joint as well as the bones, cartilage and ligaments that form the joint itself. Some of the more common knee injuries include:

ACL injury. An ACL injury is the tearing of the anterior cruciate ligament (ACL)—one of four ligaments that connect the shinbone to the thighbone. An ACL injury is particularly common in people who play basketball, soccer, or other sports that require sudden changes in direction.

Fractures. The bones of the knee, including the kneecap (patella), can be broken during motor vehicle collisions or falls. People whose bones have been weakened by osteoporosis can sometimes sustain a knee fracture simply by stepping incorrectly.

Tom Meniscus. The meniscus is formed of tough, rubbery cartilage and acts as a shock absorber between the shinbone and thighbone. It can be torn if the knee is suddenly twisted while bearing weight on it.

Knee Bursitis. Some knee injuries cause inflammation in the bursae, the small sacs of fluid that cushion the outside of the knee joint so that tendons and ligaments glide smoothly over the joint.

Patellar tendinitis. Tendinitis is irritation and inflammation of one or more tendons—the thick, fibrous tissues that attach muscles to bones. Runners, skiers, cyclists, and those involved in jumping sports and activities are prone to develop inflammation in the patellar tendon, which connects the quadriceps muscle on the front of the thigh to the shinbone.

Some examples of mechanical problems that can cause knee pain include:

Loose body. Sometimes injury or degeneration of bone or cartilage can cause a piece of bone or cartilage to break off and float in the joint space. This may not create any problems unless the loose body interferes with knee joint movement, in which case the effect is something like a pencil caught in a door hinge.

Iliotibial band syndrome. This occurs when the tough band of tissue that extends from the outside of the hip to the outside of the knee (iliotibial band), becomes so tight that it rubs against the outer portion of the femur. Distance runners are especially susceptible to iliotibial band syndrome.

Dislocated kneecap. This occurs when the triangular bone (patella) that covers the front of the knee slips out of place usually to the outside of the knee. In some cases the kneecap may stay displaced.

Hip or foot pain. If hip or foot pain is present, it may change the way one walks to spare these painful joints. But this altered gait can place more stress on the knee joint. In some cases, problems in the hip or foot can refer pain to the knee.

More than 100 different types of arthritis exist. The varieties most likely to affect the knee include:

Osteoarthritis (OA). Sometimes called degenerative arthritis, osteoarthritis is the most common type of arthritis. It's a wear-and-tear condition that occurs when the cartilage in the knee deteriorates with use and age.

Rheumatoid arthritis. The most debilitating form of arthritis, rheumatoid arthritis is an autoimmune condition that can affect almost any joint in the body, including knees. Although rheumatoid arthritis is a chronic disease, it tends to vary in severity and may even come and go.

Gout. This type of arthritis occurs when uric acid crystals build up in the joint. While gout most commonly affects the big toes, it can also occur in the knee.

Pseudogout. Often mistaken for gout, pseudogout is caused by calcium-containing crystals that develop in the joint fluid. Knees are the most common joint affected by pseudogout.

Septic arthritis. Sometimes the knee joint can become infected, leading to swelling, pain and redness. There's usually no trauma before the onset of pain. Septic arthritis often occurs with fever.

Patellofemoral pain syndrome is a general term that refers to pain arising between your patella and the underlying thighbone (femur). It's common in athletes; in young adults, especially those who have a slight maltracking of the kneecap; and in older adults, who usually develop the condition as a result of arthritis of the kneecap.

The most common conditions that can be treated by the invention include: From a clinical point of view, joint distraction as a treatment for osteoarthritis (OA) of the hip and ankle has been demonstrated to be very promising. Pain, reduced joint mobility and decreased functional ability are the most common complaints for a patient with severe OA. Traction therapy has been shown to increase osteogenesis, angiogenesis, and improve viscoelastic properties. OA will be the most commonly treated knee problem with the invention.

This invention is particularly effective for treating moderate to severe osteoarthritis that requires load reduction to the affected medical and lateral compartments of the knee. The invention provides decompression to the knee joint by re-establishing the natural space and cushioning that's missing between the femur and the tibia when afflicted with osteoarthritis. Any loss of cartilage between the knee joint or even a sudden increase in weight can strain the knee and cause painful inflammation.

The invention will be most effective with mild to moderate OA of the knee, however, severe OA can experience significant improvement, especially when combined with other modalities such as laser therapy. Mild disease is defined as being confined to the upper third of the cartilage; moderate disease extends up to two-thirds of the cartilage, while severe disease extends beyond these anatomical limits.

Osteochondritis dissecans is a joint condition in which bone underneath the cartilage of a joint dies due to lack of blood flow. This bone cartilage can then break loose, causing pain and possibly hinder joint motion.

Osteochondritis dissecans occurs most often in children and adolescents. It can cause symptoms either after an injury to a joint, or after several months of activity, especially high impact activity such as jumping and running, that affects the joint. The condition occurs most commonly in the knee, but also occurs in elbows, ankles and other joints. The invention is an effective treatment option if the bone or cartilage is attached.

The Meniscus is a piece of cartilage that provides a cushion between the thighbone (femur) and shinbone (tibia). There are two menisci in each knee joint. They can be damaged or torn during activities that put pressure on or rotate the knee joint. Taking a hard tackle on the football field or sudden pivot on the basketball court can result in a meniscus tear.

Due to the angiogenesis effects of traction and laser treatments, meniscus tears generally respond very well to the treatment. It has been noted that 50% of meniscus tears will heal on their own, however, this is done in a very slow manner due to the lack of adequate blood supply to the cartilage. Traction therapy has been shown to increase blood flow, thereby, decreasing healing times.

Sprains/strains are the most common injury to the knee. The invention will provide a treatment option after the acute phase has ended. Intermittent traction is necessary to create the proper motion needed for soft tissue repair.

Traction therapy has been successfully used for decades in the treatment of cervical and lumbar spine injuries and conditions. Surgical traction of the knee and hips has also shown promising results with osteogenic, angiogenic, and visco-elastic changes due to joint traction/distraction. Although attempted, devices that provide non-surgical mechanical traction to the knee or hip, has been very limited until now. With the advent of the present invention, this type of treatment modality can effectively be performed in a clinical setting that allows a reproducible and repeatable option to obtain the benefits of tractions therapy to the knee.

### BRIEF SUMMARY OF SOME OF THE PREFERRED EMBODIMENTS

The invention disclosed herein includes a mechanism for securing a portion of a leg above the knee to a stationary object and securing a portion of the leg below the knee to a movable object with the leg in a generally fully extended condition. A variable tension force can be applied to the lower leg securing mechanism to thereby stretching the knee joint in an axial direction with respect to the extended leg. The invention may be fitted with a controller system which allows the invention to be operated wirelessly from a mobile device running a mobile application, which may communicate with a web-based portal and/or database.

The stretching of the knee joint in an axial direction helps to increase the blood flow within the knee thereby stimulating tissue growth and lubricating the knee both of which alleviate knee abnormalities as discussed above.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a side view of an embodiment of the apparatus for treating knee abnormalities;

FIG. 2 illustrates a frontal view of an embodiment of the apparatus for treating knee abnormalities;

FIG. 3 illustrates a perspective view of an embodiment of the apparatus for treating knee abnormalities;

FIG. 4 illustrates a perspective view of a portion of an embodiment of the apparatus for treating knee abnormalities;

FIG. 5 illustrates a perspective view of an extension mechanism for a lower leg support member;

FIG. 6 illustrates a perspective view of a front portion of an extender attached to an underside of the main housing member;

FIG. 7 illustrates a block diagram of a controller system for controlling operation of the apparatus for treating knee abnormalities;

FIG. 8 illustrates an embodiment of protocol completion function for completing performance of one or more protocols for operating the apparatus for treating knee abnormalities;

FIG. 9 illustrates a first example embodiment protocol for operating the apparatus for treating knee abnormalities;

FIG. 10 illustrates a second example embodiment protocol for operating the apparatus for treating knee abnormalities;

FIG. 11 illustrates a third example embodiment protocol for operating the apparatus for treating knee abnormalities;

FIG. 12 illustrates a fourth example embodiment protocol for operating the apparatus for treating knee abnormalities; and

FIG. 13 illustrates a fifth example embodiment protocol for operating the apparatus for treating knee abnormalities.

### DETAILED DESCRIPTION OF THE PREFERRED EMBODIMENTS

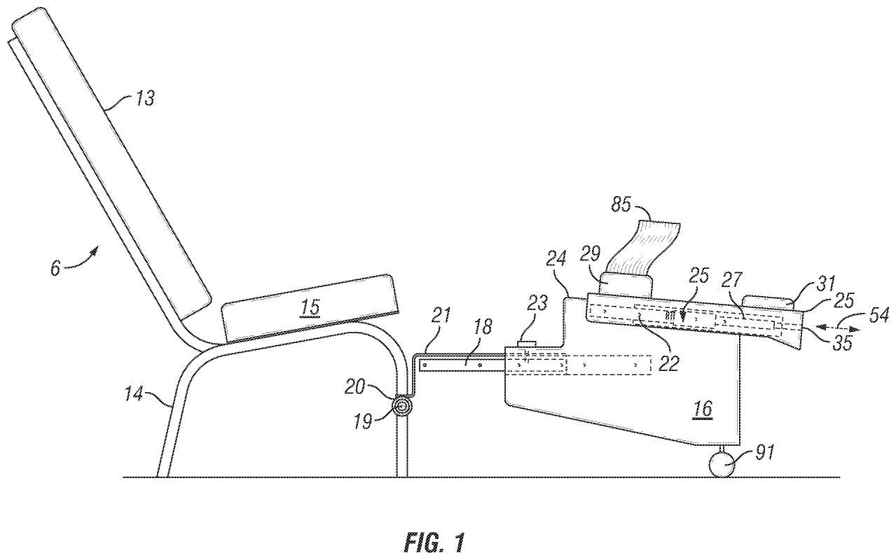

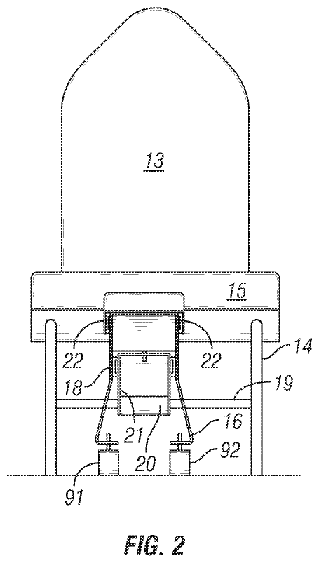

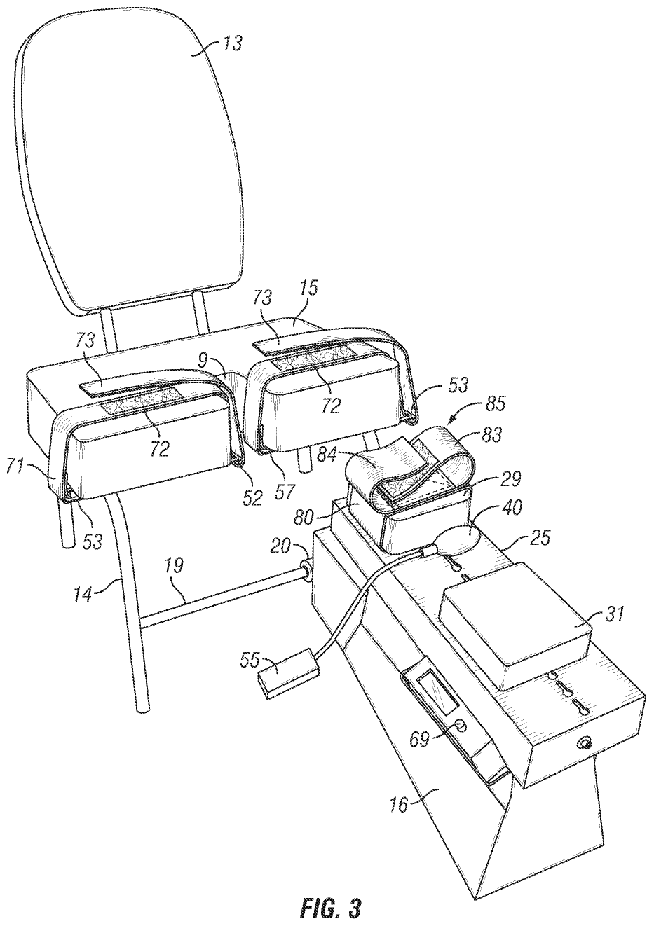

As shown in FIGS. 1 and 3, an embodiment of the invention includes two components fixed together. The first component 6 is a seating arrangement for the patient. It includes a support frame 14, a back rest 13, and a seating surface 15. Support frame 14 includes a laterally extending rod 19.

Seating arrangement 6 also includes a u-shaped cut out section 9 (FIG. 3) in a middle portion of the seat to accommodate a pair of strap guiding bars 52, 57 secured to the frame. The two sides of the chair include a support bar 53 to which a first end of the straps 71 are secured to. Portion 72 of the strap is adapted to be placed over the patient's upper leg portion, through loop 52 and then back over portion 72 as shown at 73.

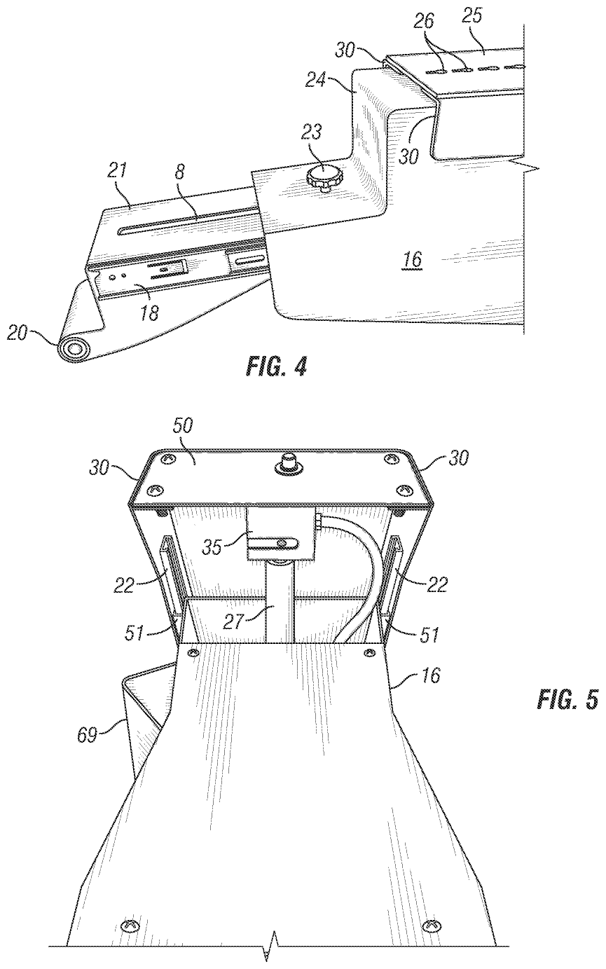

The lower leg support and stretching component includes a first guide housing 21 as shown in FIG. 4 that includes a tubular bearing 20 that is adapted to slide laterally on rod 19. A main housing member 16 which includes ground engaging rollers 91,92 is slideably attached to guide housing 21 by conventional side tracks 18 which slide in complementary shaped tracks attached to an inner wall of main housing 16. The axial position of main housing 16 with respect to guide housing 21 can be adjust by turning a knob 23 which has a pin sliding in slot 8 provided in the top surface of guiding housing 21. The pin is threaded to receive a nut which slides under slot 8.

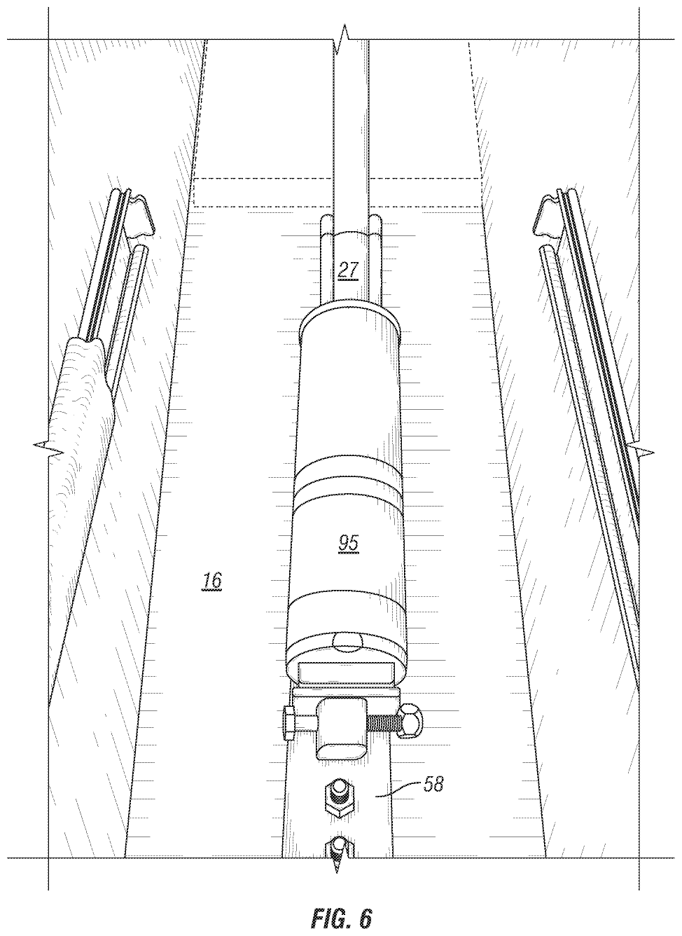

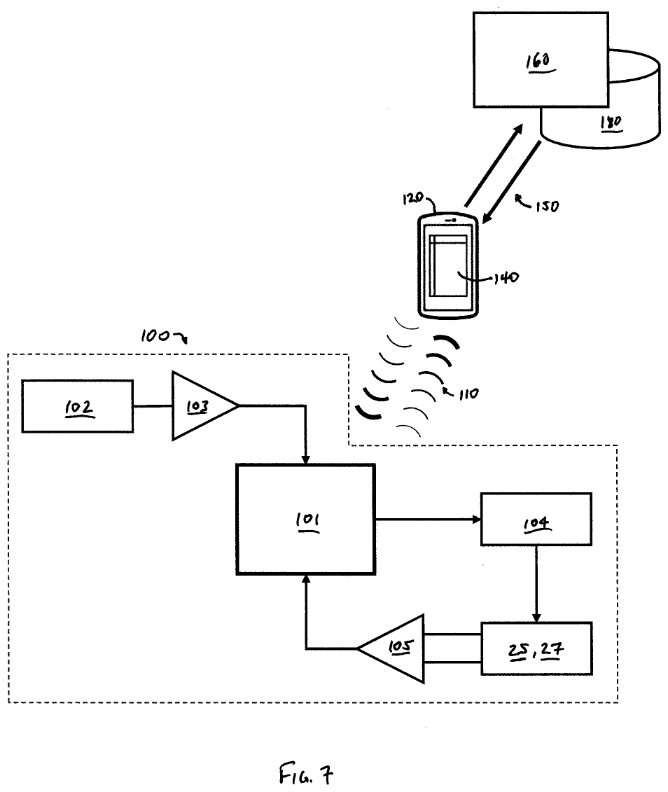

A lower leg support platform 25 is slideably mounted on the main housing 16 and includes a pair of downwardly extending side flaps 30. A plurality of adjustment holes 26 are located on the top surface of support platform 25. Holes 26 includes a slot portion and an enlarged portion to accommodate pins, which have an enlarged head portion, extending downwardly from cushions 29, 31 in a known manner. A first strap 80 tightly surrounds and is attached to cushion 29. A second strap 85 having end portions 83, 84 is secured to the top portion of first strap 80. Hook and loop fasteners are provided on end portions 83, 84 respectively so that the lower portion of the leg below the knee can be secured to cushion 29 which is secured to platform 25. Cushion 31 is for supporting the patient's foot and is optional. It may also include a securing strap. The support platform 25 includes side mounted tracks 22 as shown in FIGS. 1 and 5 that slide within complimentary shaped rails 51 secured to the outer surface of main housing 16. Rails and tracks that are commonly used in desk drawers may be used as an example, however any known mechanism for slideably supported one member within another may be used.

Lower leg supporting platform 25 includes an end plate 50 as shown in FIG. 5. One end 27 of a progressive force linear actuator available from Progressive Automations is connected to end plate 50 via a force sensor 35. The other end 95 of the linear actuator is fixed to the underside of top surface 24 of main housing 16 by a bracket 58. Thus extension of the linear actuator will cause support platform 25 to move with respect to main housing 16 in an axial direction as depicted at 54 in FIG. 1.

### Mode of Operation

In operation, a patient is seated and the leg is fully extended so that the lower portion of the leg below the knee is supported by cushion 29 and the foot rests on cushion 31. Housing 16 may be axially adjusted as necessary as shown at 55. Housing 16 is laterally moved so as to be aligned with the knee to be treated. The upper portion of a leg is secured to the chair frame 14 by a strap having hooks and loops fasteners for example. The strap may be mounted on one side of the chair at 53, placed over the knee at 72 and through the space between bar 52 and the U-shaped cutout, and then tightened folded back over the knee at 73 and secured to section 72 by a hook and loop fastener.

The lower portion of the leg is secured to the movable platform 25 on cushion 29 in a similar manner, however the arrangement for securing both portions of the leg to the chair support frame and the moveable support platform may include any known arrangement.

Optionally an inflatable bladder 55 having an air pump 40 may be positioned between the leg portion and the strap to firmly secure the leg portion to the support platform. With the leg secured above and below the knee, a linear force is applied to the knee via linear actuator 95, 27 and support platform 25 which results in the knee joint being stretched between 0.0 and 10 millimeters for example. The amount of force, duration of the force and intervals between the application of force can be varied by a suitable control mechanism known in the art. The amount of force applied may be in the range of five to thirty pounds, for example with intervals of 0 to thirty seconds, again for example. For a given cycle the applied force can vary from a given starting value to a greater end value, for example eighteen to twenty-two pounds. A control module 69 is attached to housing 16 for inputting data into a central processor which controls movement of the linear actuator.

### Controller System

In the description that follows, the terms “therapeutic apparatus” or “therapeutic apparatuses” are used to refer to one or more apparatuses for treating knee abnormalities.

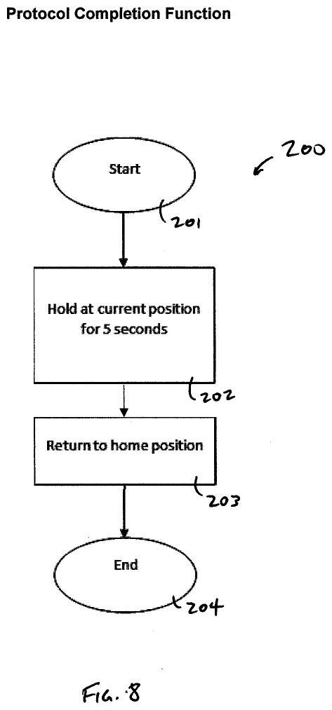

Referring now to FIG. 7, the therapeutic apparatus disclosed herein may be fitted with controller system 100 in place of control module 69. Controller system 100 may comprise one or more components which may include, but not be limited to, a power supply (not shown), microcontroller 101, load cell 102, load cell amplifier 103, motor driver 103, and position feedback system 105, any of which may be disposed within a housing which may be secured to the therapeutic apparatus, and which may be disposed in a location readily accessible to a person operating or using the therapeutic apparatus. In an embodiment, controller system 100 may be built, formed, assembled, or tested in accordance with, or in order to obtain, one or more certifications, for example UL, CE, or FDA certification. In embodiments of the therapeutic apparatus comprising controller system 100, force sensor 35 may comprise, or be replaced by, load cell 102, load cell 102 may be in communication with load cell amplifier 103, load cell amplifier 103 may be in communication with microcontroller 101, microcontroller 101 may be in communication with motor driver 104, motor driver 104 may be in communication with linear actuator 25,27, linear actuator 25,27 may be in communication with position feedback system 105, and position feedback system 105 may be in communication with microcontroller 101. In embodiments, the method of each communication between the components just described may be electrical, mechanical, or other suitable form of communication.

Controller system 100 may be capable of being remotely operated, which may allow one or more parameters of operation of the therapeutic apparatus to be varied individually or in one or more sequences or protocols. In embodiments, controller system 100 may communicate with mobile device 120 via a suitable short-range wireless networking medium 110, for example a Bluetooth® short-range wireless network. Mobile device 120 may communicate with web portal 160 and/or database 180 via a suitable network communications medium 150, which may comprise a wired or wireless network communications medium, or combinations thereof. Mobile application 140 may be installed on, and operate from, mobile device 120, and may be in communication with controller system 100 via short-range wireless networking medium 110, and may communicate with web portal 160 and/or database 180 via network communications medium 150. In embodiments, mobile device 120 may be any device capable of mobility on which mobile application 140 may be installed, for example mobile device 120 may be a mobile phone, a smart phone, a tablet computer, a laptop computer, or other suitable mobile device.

The one or more parameters which may be varied by controller system 100 may include, without limitation, the linear force or pressure applied to the knee, a length of extension of linear actuator 25,27, a duration of time during which the linear force may be applied or the length of extension may be held, or combinations thereof.

In embodiments, a parameter defining the linear force may comprise a range of forces bounded by a minimum value and a maximum value. For example, the linear force may comprise a range of forces between a minimum value of zero pounds to a maximum value of thirty pounds. In different exemplary embodiments, the linear force may comprise a range between zero pounds and eight pounds, between zero pounds and thirteen pounds, between zero pounds and eighteen pounds, between zero pounds and twenty-three pounds, or between zero pounds and thirty pounds.

In embodiments, a parameter defining the length of extension of linear actuator 25,27 may comprise a range of lengths bounded by a minimum value and a maximum value. For example, the length of extension may comprise a range of lengths between a minimum length, or home position, measuring zero inches from a point of reference located on, or in proximity to, the linear actuator, to a maximum length, or maximum position, measuring ten inches from the point of reference located on, or in proximity to, the linear actuator. In different exemplary embodiments, the length of extension may comprise a range between zero inches and two inches, between zero inches and four inches, between zero inches and six inches, between zero inches and eight inches, or between zero inches and ten inches.

In embodiments, a parameter defining the duration of time during which the linear force may be applied or the length of extension may be held may comprise a range of durations bounded by a minimum value and a maximum value. For example, the duration may comprise a range between zero seconds to a maximum of 600 seconds (ten minutes) or longer. In different exemplary embodiments, the duration may comprise a range between zero seconds and 120 seconds, between zero seconds and 240 seconds, between zero seconds and 360 seconds, between zero seconds and 420 seconds, between zero seconds and 480 seconds, or between zero seconds and 600 seconds.

Controller system 100 may be configurable to perform one or more calibration processes, for example to calibrate a linear force or pressure applied to the knee, or a length of extension of linear actuator 25,27.

In an embodiment, the one or more calibration processes may comprise calibrating the linear force to one or more known or observed measures of force, which may be provided by, or set by, a person initiating or observing the calibration process. For example, controller system 100 may calibrate the linear force to a reading observed on a scale attached to the therapeutic apparatus, wherein the scale may be selected to measure a force within an acceptable margin of error. In different exemplary embodiments, controller system 100 may be calibrated to a scale reading five pounds, ten pounds, fifteen pounds, twenty pounds, twenty-five pounds, thirty pounds, or combinations thereof. In this manner, when controller system 100 may be executing a protocol directing that a predetermined or desired linear force be applied to the knee, controller system 100 will be calibrated so as to apply the predetermined or desired linear force to the knee within an acceptable margin of error.

In an embodiment, the one or more calibration processes may comprise calibrating the length of extension of linear actuator 25,27 to one or more known or observed measures of length, which may be provided by, or set by, a person initiating or observing the calibration process. For example, controller system 100 may calibrate the length of extension based upon configuring linear actuator 25,27 in a first position, which controller system 100 may be set to recognize as a minimum extended position, and separately configuring linear actuator 25,27 in a second, extended position, which controller system 100 may be set to recognize as a maximum extended position. In embodiments, the first and second positions may each correspond to a measure of length from one or more reference points located about the therapeutic apparatus, or one or more components thereof, and controller system 100 may be configured to recognize each position based on a unit of measure of length from the one or more reference points, within an acceptable margin of error. In this manner, when controller system 100 may be executing a protocol directing that linear actuator 25,27 be extended to a predetermined or desired length of extension, or a predetermined or desired percentage of extension, controller system 100 will be calibrated so as to extend linear actuator 25,27 to the predetermined or desired length of extension within an acceptable margin of error.

Controller system 100 may be configured to perform, or execute, one or more protocols providing one or more methods of treatment, during which the linear force or pressure applied to the knee, the length of extension of linear actuator 25,27, the duration during which the linear force or pressure may be applied, or the length of extension may be held, or combinations thereof, may be varied. Embodiments of such protocols may include a static traction protocol, an intermittent traction protocol, a gradient traction protocol, or combinations thereof in whole or in part. Controller system 100 may also be configured to perform a protocol completion function. In embodiments, each of the one or more protocols providing one or more methods of treatment may also include such a protocol completion function as part of the one or more protocols.

In embodiments, any of the one or more parameters which may be varied by controller system 100 may be configured by a person operating or using the therapeutic apparatus prior to, or during, performance of the one or more protocols. In this manner, controller system 100 may be provided with a maximum value of the linear force or pressure applied to the knee, a maximum length of extension of linear actuator 25,27, a maximum duration during which the linear force may be applied or the length of extension may be held, a number of cycles for all or a portion of a protocol to be repeated, or pluralities or combinations thereof, or other such parameters which may be relevant to a protocol. In embodiments, these configured parameters may define one or more maximum values of one or more ranges of parameters to be applied throughout a pending session during which a protocol may be performed, or a remaining portion of a current session during which a protocol may be performed. In embodiments, these configured parameters may correspond to one or more therapeutic treatments which may be desired or prescribed, for example by a therapeutic professional, health care provider, or doctor.

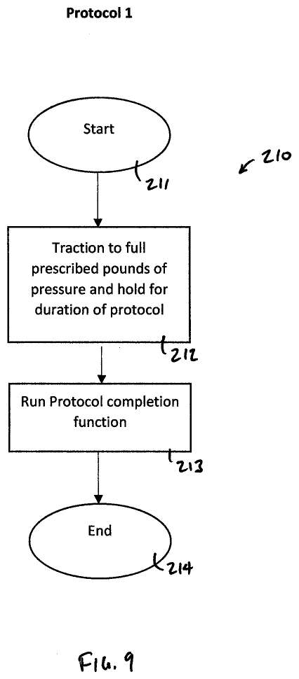

FIG. 8 illustrates an embodiment of protocol completion function 200. Starting at method step 201, protocol completion function 200 may pause changes in the linear force or pressure applied to the knee, or the length of extension of linear actuator 25,27, for a predetermined or desired duration at method step 202, for example, 5 seconds, after which linear actuator 25,27 may be caused by controller system 100 to be returned to a first, minimum, or home position at method step 203, with protocol completion function 200 ending at method step 204.

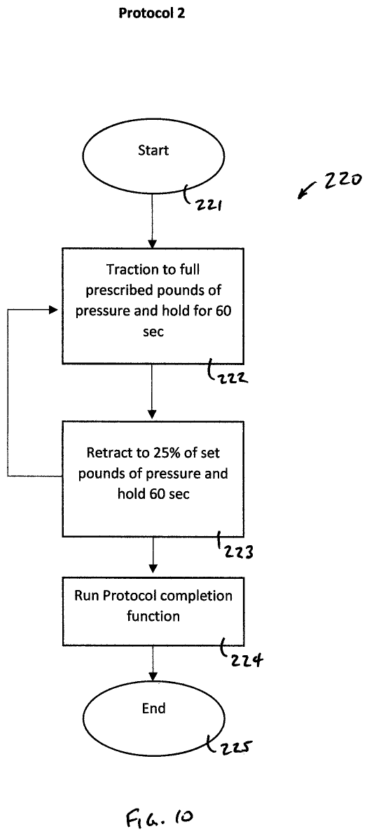

FIG. 9 illustrates an example static traction protocol method 210. Starting at method step 211, static traction protocol 210 may comprise controller system 100 causing the linear force or pressure applied to the knee to be transitioned from a first state to a second state at method step 212, where the linear force or pressure may be held for a duration of time. In embodiments, the second state may comprise a value of linear force or pressure to be applied to the knee provided to controller system 100 as a configured parameter. Similarly, the duration of time may comprise a duration of time provided to controller system 100 as a configured parameter. For example, performance of a static traction protocol by controller system 100 may cause a linear force or pressure applied to the knee to transition from zero pounds to a non-zero measure of force in pounds, for example 10 pounds, 20 pounds, or 30 pounds, or any such amount of force, where it may be held for a duration of time, for example 60 seconds, 120 seconds, 240 seconds, 360 seconds, 480 seconds, or 600 seconds, or any such duration of time. Upon expiry of the duration of time, controller system 100 may cause the protocol completion function to be executed or performed at method step 213, followed by static traction protocol 210 ending at method step 214.

In an embodiment, an intermittent traction protocol may comprise controller system 100 causing the linear force or pressure applied to the knee to be transitioned from a first state to a second state, where the linear force or pressure may be held for first duration of time, after which the linear force or pressure may be transitioned to a fraction or percentage of the value of the second state, where the linear force or pressure may be held for a second duration of time. The intermittent traction protocol may then comprise controller system 100 causing this cycle to be repeated for a number of cycles, after which controller system 100 may cause the protocol completion function to be performed. Embodiments of an intermittent traction protocol may comprise maximum values of the linear force or pressure applied to the knee, values of the first or second durations of time during which the linear force or pressure may be held, or the number of cycles to be provided to controller system 100 as one or more configured parameters.

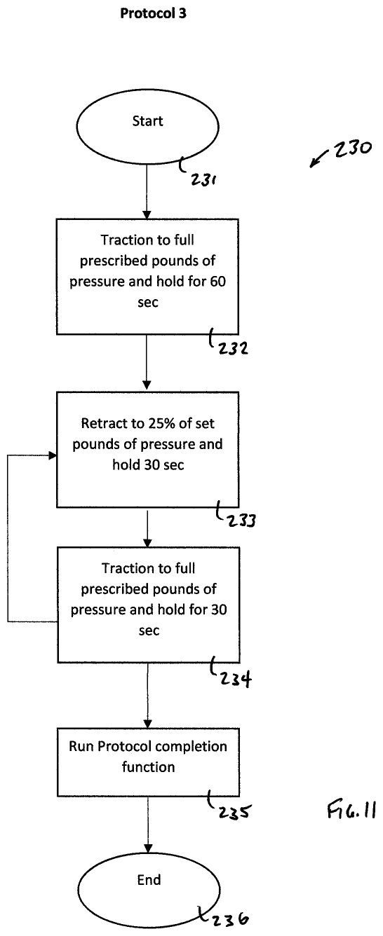

FIG. 10 illustrates a first example intermittent traction protocol 220. Starting at method step 221, intermittent traction protocol 220 may comprise the linear force or pressure applied to the knee to be transitioned from zero pounds to a 100% of the configured amount of force, where it may be held for a duration of 60 seconds at method step 222, after which the linear force or pressure applied to the knee may be reduced to 25% of the configured amount of force, where it may be held for a duration of 60 seconds at method step 223, after which this cycle may be repeated for a configured number of cycles, followed intermittent traction protocol 220 causing the protocol completion function to be performed at method step 224, after which intermittent traction protocol 220 may end at method step 225.

In alternate embodiments, an intermittent traction protocol may comprise controller system 100 causing the linear force or pressure applied to the knee to be transitioned from a first state to a second state, where the linear force or pressure may be held for a first duration of time, after which the linear force or pressure may be transitioned to a fraction or percentage of the value of the second state, where the linear force or pressure may be held for a second duration of time. The intermittent traction protocol may then comprise controller system 100 causing this cycle to be repeated at the second duration of time for a number of cycles, after which controller system 100 may cause the protocol completion function to be performed. In operation, this method of treatment may comprise alternating cycles of extension and relaxation, and may further comprise varying one or more parameters of linear force or duration during each successive cycle. Embodiments of such an intermittent traction protocol may comprise maximum values of the linear force or pressure applied to the knee, values of the first or second durations of time during which the linear force or pressure may be held, or the number of cycles to be provided to controller system 100 as one or more configured parameters.

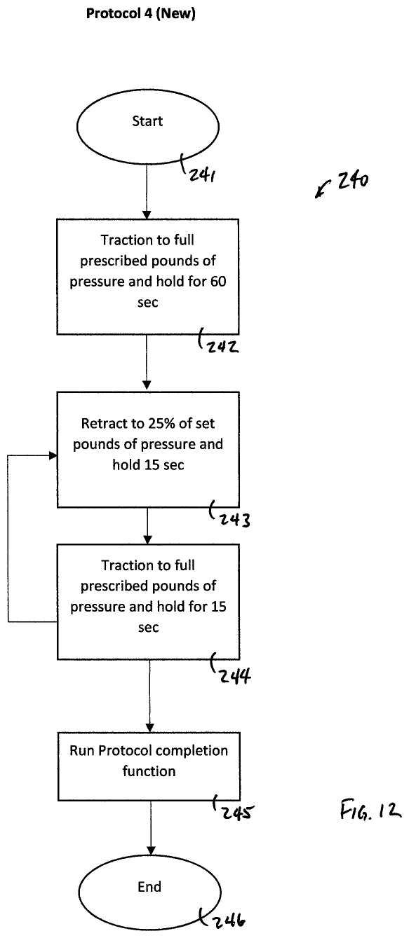

FIG. 11 illustrates a second example intermittent traction protocol 230. Starting at method step 231, intermittent traction protocol 230 may comprise the linear force or pressure applied to the knee to be transitioned from zero pounds to 100% of the configured amount of force where it may be held for a duration of 60 seconds at method step 232. The linear force or pressure applied to the knee may then be reduced to 25% of the configured amount of force where it may be held for a duration of 30 seconds at method step 233, after which the linear force or pressure applied to the knee may be transitioned to the full configured amount of force, where it may be held for a duration of 30 seconds at method step 234, with controller system 100 causing this cycle to be repeated for a configured number of cycles, followed by intermittent traction protocol 230 causing the protocol completion function to be performed at method step 235, after which intermittent traction protocol 230 may end at method step 236.

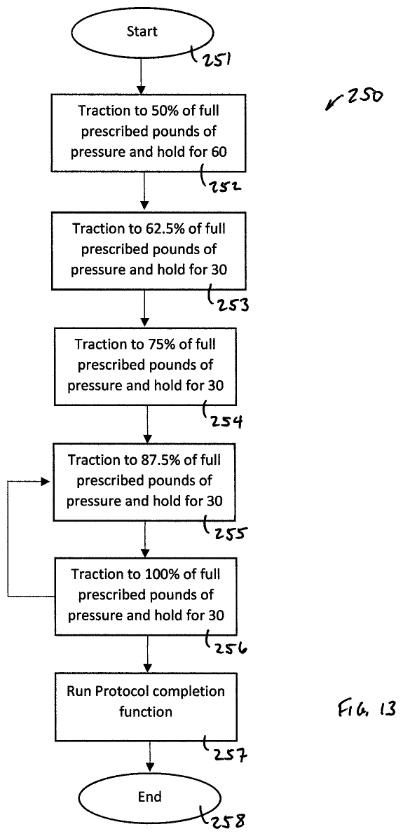

FIG. 12 illustrates a third example intermittent traction protocol 240. Starting at method step 241, intermittent traction protocol 240 may comprise the linear force or pressure applied to the knee to be transitioned from zero pounds to 100% of the configured amount of force, where it may be held for a duration of 60 seconds at method step 242. The linear force or pressure applied to the knee may then be reduced to 25% of the configured amount of force where it may be held for a duration of 15 seconds at method step 243, after which the linear force or pressure applied to the knee may be transitioned to the full configured amount of force, where it may be held for a duration of 15 seconds at method step 244, with controller system 100 causing this cycle to be repeated for a prescribed number of cycles, followed by intermittent traction protocol 240 causing the protocol completion function to be performed at method step 245, after which intermittent traction protocol 240 may end at method step 246.

In an embodiment, a gradient traction protocol may comprise controller system 100 transitioning through varying amounts of linear force or pressure applied to the knee, which may be held for a same or differing duration. For example, a gradient traction protocol may comprise the percentage of the prescribed amount of linear force to be varied among each cycle, and may further comprise incrementally increasing or incrementally decreasing the percentage of linear force across each successive cycle. Similarly, the prescribed duration of each extension cycle and each relaxation cycle may be the same or may be varied between cycles, and may be incrementally increased or incrementally decreased across each successive cycle. Upon completion of a predetermined or desired number of such varying cycles, controller system 100 may cause the protocol completion function to be executed or performed. Embodiments of a gradient traction protocol may comprise maximum values of the linear force or pressure applied to the knee, values of one or more durations of time during which the linear force or pressure may be held, a number of steps or cycles, or a pattern of increasing or decreasing changes of the linear force or pressure applied to the knee to be provided to controller system 100 as one or more configured parameters.

FIG. 13 illustrates an embodiment of gradient traction protocol 250. Starting at method step 251, gradient traction protocol 250 may comprise the linear force or pressure applied to the knee first transitioning to 50% of a configured amount of force, where it may be held for a duration of 60 seconds at method step 252. Gradient traction protocol 250 may then transition the linear force or pressure applied to the knee to 62.5% of the configured amount of force, where it may be held for a duration of 30 seconds at method step 253. Gradient traction protocol 250 may then transition the linear force or pressure applied to the knee to 75% of the configured amount of force, where it may be held for a duration of 30 seconds at method step 254. Gradient traction protocol 250 may then transition the linear force or pressure applied to the knee to 87.5% of the configured amount of force, where it may be held for a duration of 30 seconds at method step 255. Gradient traction protocol 250 may then transition the linear force or pressure applied to the knee to 100% of the configured amount of force, where it may be held for a duration of 30 seconds at method step 256, followed by gradient traction protocol 250 causing the protocol completion function to be performed at method step 257, after which gradient traction protocol 250 may end at method step 258.

In embodiments, controller system 100 may be configured to provide a pause function, whereby a person operating or using the therapeutic apparatus may pause the performance of a protocol. When in the paused state, the person operating or using the therapeutic apparatus may adjust one or more configured parameters of the paused protocol, for example a maximum value of the linear force or pressure applied to the knee, independent of the protocol, or as an input to the protocol which may subsequently be applied by the protocol upon removing the protocol from the paused state.

The therapeutic apparatus may be configured with one or more physical mechanisms to immediately suspend or terminate any protocol which may be executing. In embodiments, the one or more physical mechanisms may disposed about the therapeutic apparatus in a location which may be readily accessible to a person operating or using the therapeutic apparatus. In embodiments, activation of the one or more physical mechanisms may cause power to the therapeutic apparatus, or controller system 100, to be shut off, and may also cause the linear force or pressure applied to the knee, or length of extension of linear actuator 25,27, to return to a first, minimal, or “home” position.

Controller system 100 may be configured to recognize, and adjust in response to, one or more levels of errors which may be encountered while performing or executing one or more protocols, which may be communicated to controller system 100 by one or more sensors disposed about the therapeutic apparatus, or one or more components thereof. For example, controller system 100 may be configured to recognize general errors or critical errors which may be encountered during operation of a protocol. In embodiments, a general error may comprise any error of operation which may not result in shutdown of controller system 100, whereas a critical error may be any error which may result in shutdown of controller system 100. In embodiments, controller system 100, or a device or application which may be in communication with controller system 100, may record or log any such errors which may be identified during operation, and for critical errors may cause shutdown of the therapeutic apparatus, or controller system 100, in the manner previously described, or for general errors may pause the current session or protocol and prompt a person operating or using the therapeutic apparatus to select to “continue” or “end” the current session or protocol.

Examples of errors which may be considered general may include failure to execute a command, controller system 100 not being calibrated, encountering an error during calibration, failure of an actuator or sensor, movement of an actuator in an incorrect direction, an inability of an actuator to extend to a minimum or maximum length of extension, a device not being positioned in a first, or home, position, an error in pausing or resuming operation of one or more components, an actuator meeting or exceeding a minimum or maximum position or length, a force or pressure exceeding a maximum force or pressure, or controller system 100 load cell inconsistency, floating, or falling outside boundary values. Examples of errors which may be considered critical errors may include a load cell of controller system 100 reading a state of error, or activation of the one or more physical mechanisms previously described which may be intended to suspend or terminate a performance or execution of a protocol.

In embodiments, during operation, one or more parameters or aspects of operation of one or more protocols being performed or executed may be presented to a person operating or using the therapeutic apparatus. In embodiments, these one or more parameters or aspects of operation may include, but not be limited to: the name, or type, of protocol being performed or executed, or a plurality or sequence thereof; the elapsed time, or time remaining, of the protocol or session being performed or executed, or a portion or sequence thereof; the current, configured, or prescribed linear force, or pounds of pressure, being, or to be, applied to the knee; the current, configured, or prescribed length of extension being, or to be, applied to the knee, which may be applied by linear actuator 25,27; or combinations thereof. In embodiments, such parameters may be presented on a display forming part of the therapeutic apparatus, or through a mobile device, a mobile application, or a web-based application configured to communicate with controller system 100.

As mentioned previously, in embodiments, controller system 100 may communicate with mobile device 120, on which mobile application 140 may be installed, and vice-versa, and mobile application 140 may communicate through mobile device 120 with web portal 160, or database 180, and vice-versa.

Web portal 160 may be any suitable web-based application which may be accessible through known internet browsing applications or web browsers. Web portal 160 may comprise one or more web-based user interfaces, and one or more databases 180 which may be accessible via the one or more user interfaces. Each of the one or more databases 180 may comprise one or more data tables, which may allow one or more data records to be created, stored, retrieved, updated, or deleted. In embodiments, web portal 160 and/or database 180 may be hosted on one or more processing platforms, for example one or more servers, which may be accessible via a suitable wired or wireless communications medium, or combinations thereof.

In embodiments, web portal 160 may be configured to require a person desiring access to web portal 160 to be authenticated prior to being granted access to interact with the one or more user interfaces, or create, store, retrieve, update, or delete the one or more data tables or data records of database 180. For example, web portal 160 may be configured to require each person being granted access to web portal 160 to be provided with a unique user name and a password known only to the person, and web portal 160 may be configured to authenticate a person by requiring that the person provide their user name and a password prior to being granted access to web portal 160, which web portal 160 may verify match a user name and password combination stored within web portal 160 or database 180 prior to granting the person access to web portal 160. In embodiments, web portal 160 may allow an authenticated person to continue to access web portal 160 until the authenticated person terminates the session during which they were granted access to web portal 160, or after a predetermined amount of time has elapsed during which web portal 160 may have determined the authenticated person may not be actively interacting with web portal 160.

In embodiments, database 180 may comprise a plurality of data tables. In an exemplary embodiment, database 180 may comprise a clinics data table, a locations data table, a users data table, a machines data table, a patients data table, and a passcodes data table. The clinics data table may comprise individual data fields for clinic name, street address, city, state, postal code, telephone, website, email address, and a logo of the clinic. The locations data table may comprise individual data fields for clinic name, location name, street address, city, state, postal code, and telephone. The users data table may comprise individual data fields for user name, user role, date of birth, telephone, email address, and an assigned clinic name. The machines data table may comprise individual data fields for machine type, machine name, an assigned clinic name, an assigned location name, and a media access control (MAC) address. In this manner, each data record of the machines data table may uniquely identify a therapeutic apparatus which may be physically present at the assigned clinic or the assigned location. The patients data table may comprise individual data fields for patient name, date of birth, gender, telephone, an assigned clinic name, and any medications the patient may be taking. The passcodes data table may comprise individual data fields for a passcode which may be required to be authenticated by web portal 160 prior to a person being granted access to a super user role or an administrative role which may be associated with one or more clinic data records or one or more location data records.

In embodiments, database 180 may also comprise a relational database management system (RDMS) which may be configurable to enforce minimum data requirements of one or more data records, or enforce data relationship requirements between or across one or more data tables or data records. In an exemplary embodiment, database 180 may be configured to require that each record of the clinics data table be populated with at least a clinic name, that each record of the locations table be populated with at least a clinic name, that each record of the users data table be populated with at least the user name, email address, and clinic name, that each record of the machines table be populated with all data fields, or that each record of the patients data table be populated with at least the patient name, date of birth, and assigned clinic name. The RDMS or web portal 160 may also be configured to enforce, for example, that at least one clinic data record is required, that at least one clinic data record is created before one location data record may be created, at least one clinic data record is created before one machine data record may be created, that the clinic name or email address of a user data record cannot be updated once the record is created, that the machine type, assigned clinic name, or assigned location of a machine data record cannot be updated once the machine data record is created, or that the assigned clinic name of a patient data record cannot be updated once the patient data record is created.

In embodiments, web portal 160 may be configured to allow one or more persons who may be granted access to web portal 160 to be assigned to one or more user roles, each of which may comprise differing levels of authorization to create, store, retrieve, update, or delete one or more data tables or data records. For example, web portal 160 may be configured to provide three roles, including a super user role, and administrative user role, and a general user role, and web portal 160 may be configured to require that a person being granted access to web portal 160 be assigned to one of these three roles.

In an exemplary embodiment, web portal 160 may be configured to limit an ability of a person to create, update, or delete a clinic data record to only persons assigned to the super user role. Similarly, web portal 160 may be configured to limit an ability of a person assigned to an administrative user role to add a user data record, assign a user role within a user data record, assign a clinic name or location name to a machine record, or access a patient data record to only data records assigned to the one or more clinic names to which the user may be associated. Within these or other such limitations, web portal 160 may be configured to present different user interfaces to a person authenticated to access web portal 160 based upon the authorizations associated with the authenticated user's assigned user role.

Web portal 160 may be configured to allow one or more data records to be imported into one or more data tables of database 180. In an embodiment, the ability to import data records may be limited based upon a user role. For example, the ability to import data records may be limited to persons assigned to the administrative user role, which based upon a configuration of web portal 160 previously described may further limit the ability to import data to only records relating to a clinic name to which a person assigned the administrative user role may be associated. In an embodiment, data records may be imported into the one or more data tables of database 180 via web portal 160 from any suitable data file format, for example a comma separated value (CSV) file format. For example, web portal 160 may be configured to allow a person assigned to the administrative user role to import patient data records into a patients data table of database 180 from a CSV file comprising the patient's name, date of birth, and gender, where the import may be limited to only the clinic names to which the person may be associated. Similarly, web portal 160 may be configured to allow a person assigned to the administrative user role to import user data records into a users data table of database 180 from a CSV file comprising the user's name, date of birth, and email address, where the import may be limited to only the clinic names to which the person may be associated.

Mobile application 140 may be any suitable application which may be locally installed on mobile device 120. In embodiments, mobile application 140 may be configured to require a person desiring access to interact with mobile application 140 to be authenticated prior to being granted access to interact with mobile application 140. For example, mobile application 140 may be configured to receive a user name and password from a person, which mobile application 140 may verify match a user name and password combination stored in web portal 160, database 180, or mobile application 140. In embodiments, mobile application 140 may allow an authenticated person to continue to access mobile application 140 until the person terminates the session during which they were granted access to mobile application 140, or after a predetermined amount of time has elapsed during which mobile application 140 may have determined the authenticated person may not be actively interacting with mobile application 140.

Mobile application 140 may be configured to require that a connection be established with each therapeutic apparatus intended to be controlled by mobile application 140. In embodiments, upon being authenticated to access mobile application 140, an authenticated user may select a clinic name or location name, obtained by mobile application 140 from web portal 160 or database 180 and which are associated with the authenticated user, where the authenticated user may be physically present. The selected clinic or location may then be stored by mobile application 140 as a current location. The authenticated user may then cause mobile application 140 to scan for therapeutic apparatuses which may be located within the range of the short-range networking capability of mobile device 120. Mobile application 140 may then display a listing of therapeutic apparatuses within range of mobile device 120 for which a connection has not yet been established with mobile application 140. Upon selecting a therapeutic apparatus from the listing, if the therapeutic apparatus is recorded in web portal 160 or database 180, for example in a machines data table, as being assigned to the current location, mobile application 140 will establish a connection with the selected therapeutic apparatus. If the selected therapeutic apparatus is not recorded in web portal 160 or database 180 as being assigned to the current location, then mobile application 140 may require that the therapeutic apparatus first be registered to the current location, which may be performed though web portal 160 by another person, for example a person authenticated to access web portal 160 who may be assigned to a super user role or an administrative user role.

Mobile application 140 may provide one or more user interfaces which may allow an authenticated person to view a listing of connected therapeutic apparatuses, or details of a single connected therapeutic apparatus which may include information regarding status of the therapeutic apparatus or information regarding an operational state of the therapeutic apparatus. In embodiments, a listing may display a list or grid view of one or more connected therapeutic apparatuses, which may further include for each therapeutic apparatus the type of the therapeutic apparatus, the name of the therapeutic apparatus, an image of the therapeutic apparatus, and an indication of the status of the therapeutic apparatus. In an embodiment, the status of each listed therapeutic apparatus may be displayed as a colored circle indicating whether the therapeutic apparatus may be in a ready state (for example, green), a running state (for example, blue), a paused state (for example, orange), an error state (for example, red), a calibrating state (for example, blue-green), an initiating state (for example, orange), or a not calibrated state (for example, red). Selecting a single therapeutic apparatus from a listing view may then display details of the selected therapeutic apparatus, or a user interface specific to the selected therapeutic apparatus. For example, mobile application 140 may provide an ability to modulate the selected therapeutic apparatus between a running and a pause state, and mobile application 140 may display information regarding progress of the running state, for example total time or time remaining, details of one or more protocols or configured parameters which may comprise aspects of the running state, or details of a person or patient who may be using the therapeutic apparatus. In another example, if the selected therapeutic apparatus is calibrating or in a state of error, mobile application 140 may display a message that the therapeutic apparatus is executing a calibration procedure or display details of an error detected by the therapeutic apparatus, respectively. In a further example, if the selected therapeutic apparatus is not calibrated, mobile application 140 may present a separate user interface which may allow the authenticated person to initiate calibration of the therapeutic apparatus.

Mobile application 140 may provide one or more user interfaces which may allow an authenticated person to cause a treatment command to execute on a selected therapeutic apparatus. As used herein, a “treatment” or “treatments” may comprise one or more protocols, each of which may further comprise one or more configured parameters, and “treatment command” may comprise one or more instructions which may be communicated from mobile application 140 to controller system 100 of a therapeutic apparatus in order to provide the treatment or treatments to the therapeutic apparatus. In embodiments, mobile application 140 may be configured to require that the selected therapeutic apparatus is in a status ready to accept a treatment command, which may comprise the therapeutic apparatus having first been calibrated. Mobile application 140 may also be configured to require that an authenticated person first select a patient and create a treatment command before sending a treatment command to the selected therapeutic apparatus to be executed.

In embodiments, mobile application 140 may allow an authenticated user to view a listing of patients, or a history of treatments which are associated with an individual patient, each of which may be recorded by web portal 160, database 180, or mobile application 140. Each entry in a history of treatments for a patient may comprise a date the treatment was performed, a listing of one or more protocols comprising the treatment, a listing of one or more configurations associated with each of the one or more protocols, a duration of each of the one or more protocols comprising the treatment, a name of the therapeutic apparatus on which the treatment was executed, and a name of an authenticated person who caused the treatment to be executed. An authenticated person may select a patient, following which mobile application 140 may cause a user interface to be updated to reflect that the patient selection requirement has been fulfilled. For example, once a patient is selected, mobile application 140 may change the color of a user interface element for selecting a patient, and may cause a user interface element for selecting a treatment to become accessible to the authenticated user.

In embodiments, mobile application 140 may allow an authenticated user to create a treatment command and send the treatment command to a selected therapeutic device for execution. In such embodiments, mobile application 140 may allow an authenticated user to view a listing of one or more protocols which may be performed at the therapeutic device, which may include, for example, a static traction protocol, one or more intermittent traction protocols, a gradient traction protocol, or other suitable protocols. The authenticated user may then select a desired protocol to perform, which upon selecting, mobile application 140 may display a user interface which may allow the authenticated user to configure one or more parameters related to the protocol to be included in the treatment command, for example a linear force or pressure to be applied to the knee, one or more durations of time during which the linear force or pressure, or a percentage or fraction thereof, may be applied to the knee, and the like. Upon the authenticated user having configured the one or more parameters, or accepting default configurations of the one or more parameters, mobile application 140 may display the selected protocol and/or the configurations of the one or more parameters to the authenticated user for review and acceptance, at which time mobile application 140 may also present one or more user interface elements allowing the authenticated user to adjust or accept the selected protocol, the one or more configured parameters, or various combinations or sequences thereof. In embodiments, the selected protocol and the one or more configured parameters may comprise a treatment command to be transmitted to the selected therapeutic device.

Upon being accepted by the authenticated user, mobile application 140 may cause a treatment command to be created and prepared for transmission to control system 100, at which time mobile application 140 may also cause a user interface element for selecting a treatment to change appearance, thereby indicating to the authenticated user that the treatment command is ready to be transmitted to the selected therapeutic device. The authenticated user may then select to “start” the treatment command through a user interface of mobile application 140, at which time mobile application 140 may transmit the treatment command to controller system 100 of the selected therapeutic apparatus for execution. At this time, mobile application 140 may provide a user interface which may display one or more aspects of operation related to the execution of the treatment command, or protocol thereof, in the manner previously described. At this time, mobile application 140 may also communicate one or more aspects of the treatment command to web portal 160 to be recorded in database 180, along with one or more aspects of the operation of the treatment command, for example “started,” “completed,” or “error,” based upon the progress of execution of the treatment command.

Although the present invention and its advantages have been described in detail, it should be understood that various changes, substitutions and alterations may be made herein without departing from the spirit and scope of the invention as defined by the appended claims.

What is claimed is:

1. An apparatus for treating knee abnormalities, comprising:
a chair forming a seating surface for a patient, the chair having a lower laterally extending rod;
means for securing an upper portion of the patient's leg above the knee to the seating surface;
a support platform movable with respect to the seating surface;
means for securing a lower portion of the patient's leg below the knee to the support platform, wherein the means for securing the lower portion of the patient's leg is axially movable relative to the support platform;
means for applying a tension force to the support platform whereby a tension force is applied to the knee joint for causing the knee to be stretched in an axial direction and adjacent bone surfaces of the knee to move away from each other;
a main housing for supporting the support platform, the main housing being axially fixed to the seating surface during operation and the main housing being laterally adjustable along the seating surface via a tubular bearing that is slideably mounted on the rod of the chair, wherein the main housing includes side tracks extending along the axial direction and the main housing including a bottom surface having rollers, the side tracks and the rollers having a capability to axially adjust the main housing with respect to the seating surface; and
a controller system, said controller system for providing control of the means for applying the tension force.

2. The apparatus for treating knee abnormalities of claim 1, wherein the controller system comprises a power supply, a microcontroller, one or more load cells, one or more load cell amplifiers, one or more motor drivers, one or more position feedback systems, or combinations thereof.

3. The apparatus for treating knee abnormalities of claim 2, wherein the controller system is operated wirelessly from a mobile application, said mobile application operating on a mobile device, said mobile device comprising any device capable of mobility on which the mobile application may be installed.

4. The apparatus for treating knee abnormalities of claim 3, wherein the controller system communicates with the mobile device via a wireless networking medium.

5. The apparatus for treating knee abnormalities claim 3, wherein the mobile application communicates with a web-based portal via a network communications medium, said web-based portal comprising a user interface, a database, or combinations thereof.

6. The apparatus for treating knee abnormalities of claim 1, wherein the controller system performs a calibration function to calibrate the tension force applied to the moveable support platform.

7. The apparatus for treating knee abnormalities of claim 1, wherein the means for applying the tension force to the moveable support platform is controlled by one or more protocols performed by the controller system, said one or more protocols comprising a protocol completion function.

8. The apparatus for treating knee abnormalities of claim 7, wherein the protocol completion function causes the means for applying the tension force to the moveable support platform to pause for a duration of time at a current configuration and then return to a home position.

9. The apparatus for treating knee abnormalities of claim 7, wherein the one or more protocols:
cause the means for applying the tension force to the support platform to apply all of, or one or more portions of, a prescribed tension force to the support platform;
cause the means for applying the tension force to the support platform to hold a tension force for a prescribed or predetermined duration of time;
cause the means for applying the tension force to the support platform to apply all or a portion of a prescribed force, hold all or a portion of a prescribed force, or combinations therefor, to be cycled;
or combinations thereof.

10. The apparatus for treating knee abnormalities of claim 7, wherein the one or more protocols comprises a static traction protocol, an intermittent traction protocol, a gradient traction protocol, or combinations thereof.

11. A controller system for controlling a therapeutic device, comprising:
a therapeutic device;
a controller system, comprising:
a microcontroller;
a mobile device coupled to the microcontroller by a wireless networking medium;
a mobile application operating on the mobile device, said mobile application in communication with the microcontroller;
wherein the controller is configured to control actuation of one or more movements of the therapeutic device; and
wherein the therapeutic device comprises an apparatus for treating knee abnormalities.

12. The controller system of claim 11, wherein the therapeutic device comprises a plurality of therapeutic devices.

13. The controller system of claim 11, wherein the mobile application requires a person to be authenticated before the person is allowed to access one or more user interfaces of the mobile application.

14. The controller system of claim 11, wherein the mobile application provides one or more user interfaces which allow a person to configure one or more parameters of operation of the therapeutic device.

15. The controller system of claim 11, wherein the mobile application provides one or more user interfaces which allow a person to configure one or more sequences of operation of the therapeutic device.

16. The controller system of claim 11, wherein the mobile application provides one or more user interfaces which allow a person to pause or stop operation of the therapeutic device.

17. The controller system of claim 11, further comprising web-based portal, wherein the mobile application is in communication with said web-based portal.

18. The controller system of claim 16, wherein the web-based portal comprises one or more user interfaces, one or more databases, or combinations thereof.

19. The controller system of claim 18, wherein the one or more databases comprise one or more data tables for storing one or more records, said records comprising one or more fields of information identifying a clinic, a location, a user, a machine, a patient, a passcode, or combinations thereof.

20. The controller system of claim 19, wherein the machine comprises the therapeutic device.
